(19) United States
(12) Patent Application Publication
(10) Pub. No.: US 2022/0100615 A1
(43) Pub. Date: Mar. 31, 2022

(54) METHOD AND SYSTEM FOR CLONING DATABASE AND ASSOCIATED APPLICATION

(71) Applicant: Infosys Limited, Bangalore (IN)

(72) Inventor: Ravi Jumle, Pune (IN)

(21) Appl. No.: 17/339,685

(22) Filed: Jun. 4, 2021

(30) Foreign Application Priority Data
Sep. 30, 2020 (IN) 202041042576

(51) Int. Cl. G06F 11/14

(52) U.S. Cl. CPC G06F 11/1469; G06F 11/1464; G06F 2201/80; G06F 11/1479; G06F 11/1451

(57) ABSTRACT

A method and system for cloning a database and associated application are disclosed. A Central Server is connected to source and multiple target servers over SSH protocol. The central server has a user interface through which end user can select the target environment which needs to be cloned. central server stores configuration files containing various parameter values associated with the multiple target servers. Once, the end user selects target server, the corresponding parameter values are passed from the Configuration files to a base script stored in the central server. After collecting the parameter values, the central server dynamically generates the scripts to be executed on the source and the selected target server. Finally, the source specific script is sent to the source server and target specific scripts are sent to the target Server to clone the database and its associated application.

This application claims the benefit of Indian Patent Application Serial No. 20204104.2576 filed Sep. 30, 2020, which is hereby incorporated by reference in its entirety.

### FIELD

This technique relates generally to database cloning technique, and in particular, to a method and system for cloning database and associated application by creating dynamic script.

### BACKGROUND

Database cloning is a complete and separate copy of the database and its associated application reside in a source server. Cloning of database and associated application is mainly done for development and support purpose and/or to carry out the steps and validate the same before performing upgrade on the database and its associated applications on source server. Presently, there are multiple ways the database and its applications can be cloned.

However, the present technologies require manual execution of commands or group of commands in a script (partial automation) on the respective or multiple servers separately. Further, the scripts are maintained on local file system or shared file system across multiple Servers through Network File System (NFS) mount which poses risk of access and even keeping track of the changes made in the script become difficult. Hence, there is a need of an improved technology for cloning database and associated application.

### SUMMARY

The present technique overcomes the above mentioned drawbacks and others by having a central repository connected with source and Multiple target servers through SSH protocol.

According to an example of the present technique, a method for cloning a database and associated application is disclosed. The method includes connecting a central server to a source server and one or more target servers through a network. Thereafter, the central server receives at least one input from a device of an end user, wherein the at least one input comprises an identifier of one of the one or more target servers to clone the database and associated application from the source server. After that, one or more parameter values related to the one of the one or more target servers selected by the end user are collected from one or more configuration files stored in a repository of the central server. Further, the method dynamically generates a source specific script to be executed on the source server and one or more target specific scripts to be executed on the one of the one or more selected target servers. Finally, the central server transfers the source specific script to the source server and the one or more target specific scripts to the one of the one or more selected target servers through the network to clone the database and associated application from the source server to the one of the one or more selected target servers.

According to an example of the present technique, a system for cloning a database and associated application is disclosed. The system includes a memory coupled to one or more processors which are configured to execute programmed instructions stored in the memory including, connecting a central server to a source server and one or more target servers through a network; receiving at least one input by the central server from a device of an end user, wherein the at least one input comprises an identifier of one of the one or more target servers to clone the database and associated application from the source server; collecting one or more parameter values related to the one of the one or more target servers selected by the end user from one or more configuration files stored in a repository of the central server; dynamically generating a source specific script to be executed on the source server and one or more target specific scripts to be executed on the one of the one or more selected target servers and transferring the source specific script to the source server and the one or more target specific scripts to the one of the one or more selected target servers through the network to clone the database and associated application from the source server to the one of the one or more selected target servers.

According to an example of the present technique, a non-transitory computer readable storage medium for cloning a database and associated application is disclosed. The computer readable storage medium which is not a signal stores computer executable instructions for connecting a central server to a Source server and one or more target servers through a network; receiving at least one input by the central server from a device of an end user, wherein the at least one input comprises an identifier of one of the one or more target servers to clone the database and associated application from the source server; collecting one or more parameter values related to the one of the one or more target servers selected by the end user from one or more configuration files stored in a repository of the central server; dynamically generating a source specific script to be executed on the Source server and one or more target specific scripts to be executed on the one of the one or more selected target servers and transferring the source specific script to the source server and the one or more target specific scripts to the one of the one or more selected target servers through the network to clone the database and associated application from the source server to the one of the one or more selected target servers.

### BRIEF DESCRIPTION OF THE DRAWINGS

Various embodiments of the technique will, hereinafter, be described in conjunction with the appended drawings. There is no intention to limit the scope of the technique to such blocks or objects, or to any particular technology. These simplified diagrams are presented by way of illustration to aid in the understanding of the logical functionality of one or more aspects of the instant disclosure and is not presented by way of limitation.

FIG. 1 is a flowchart, illustrating a method for cloning a database and associated application, in accordance with an embodiment of the present technique.

FIG. 2 is a flowchart, illustrating steps followed by the execution of source specific script on source server.

FIG. 3 is a flowchart, illustrating steps followed by the execution of target specific scripts on target server.

FIG. 4 is an environment diagram in which the method of cloning a database and associated application takes place, in accordance with an embodiment of the present technique.

FIG. 5 is an architectural diagram of the system for cloning a database and associated application, in accordance with an embodiment of the present technique.

FIG. 6 is a diagram of a computer system with which the present technique can be implemented.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

Exemplary embodiments of the present technique provide a method and system for cloning a database and associated application. This technique is also applicable for instances where there is more than one application are associated with the database provided. A Central Server is connected to Source and multiple Target environment over SSH protocol. The Central Server has a user interface through which end user can select the Target environment where the clone needs to be made. Central Server stores Configuration files containing various parameter values associated with the multiple target servers. Once, the end user selects target environment the corresponding parameter values are passed from the Configuration files to a base script stored in the central server. After collecting the parameter values, the central server dynamically generates the scripts to be executed on the source and the selected target server. Finally, the source specific script is sent to the source server and target specific scripts are sent to the target server to clone the database and its associated application.

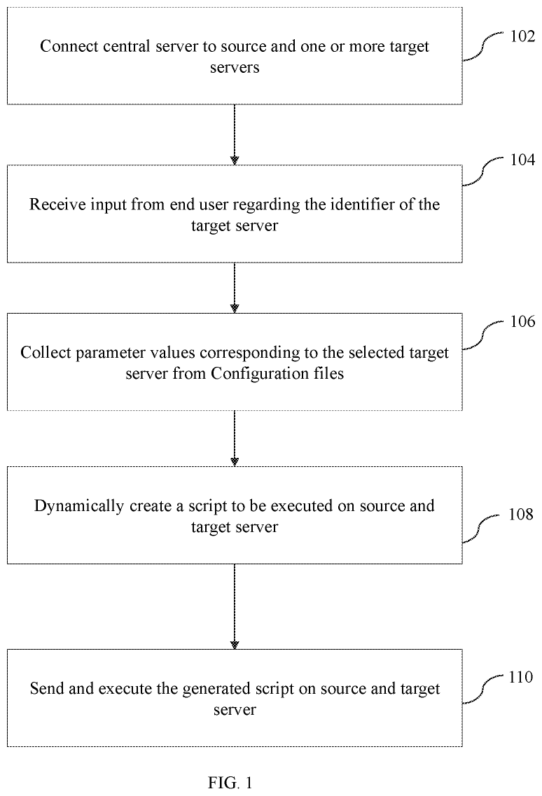

FIG. 1 is a flowchart illustrating a method for cloning a database and associated application. The method is executed in an environment which consists of a central server, a source server and multiple target servers. The central server contains Jenkins and Ant tools to automate the processes of this disclosure. Jenkins pipeline feature has been used for controlling and parallelizing the different stages/steps. At step 102, the central server is connected with the Source and multiple Target servers. The Source and multiple target servers are also connected with each other. All these servers are connected with each other through Secure Socket Shell (SSH) protocol. The SSH is a passwordless connectivity which uses digital certificates to connect with remote Servers. The SSH is a well-known standard command interface and protocol for securely gaining access to remote computer. At step 104, the central server receives input from an end user device regarding the source the target server. The central server provides a single click user interface or console at the end user device. When the end user, using the device, executes a job (i.e., Clone Automation), a prompt is provided to select the target server from the dropdown list of multiple target servers through which the central server is connected. The values (i.e. the target server name) of the target server is populated dynamically from the server configuration parameter files (server_pass_file) as describe herein below. End user can select one target server at a time from the dropdown where the clones are required to be performed. At step 106, the central server collects parameter values corresponding to the selected target server from the Configuration file stored in the central server. central server maintain scripts/codes under multiple directories: a) bin directory (maintains the scripts which make use of the scripts in different directories as per the stages/steps to be carried out on source or target server); b) build directory (contains the build (xml) files which are used by the ant script based on the input and the configuration files for carrying out transfer of scripts and command execution on source and target server); c) config directories (contain configuration related files which contains common environment details, source/target server configuration details and source/target Database details described below); d) remote directory (contains the script which will be executed on source and target server with the help of dynamic variables generated from scripts in build directory) and e) sql directory (contains the scripts which are needed to be executed either for all the target servers or specific target server in which case the script is prefixed with DB name e.g. EBSDEV_< >.sql EBSDEV_< >.lst). Among these directories, config directories store configuration files which contain common environment details, source and target environment configuration details and source and target environment database details. Configuration files can be of three types: a) server configuration parameters files (server_pass-file); b) database configuration parameter files (database_pass_file); and c) common environment files (common_env.sh).

a) Server Configuration File Parameters (Server_Pass-File):

| Parameters | Descriptions |
|---|---|
| DB | Database Name |
| DBHOST1 | Database Server Primary Hostname |
| DBHOST2 | Database Server Secondary Hostname |
| DBOWNER | Database Owner |
| ORCHOME | Database Home Path |
| APPHOST1 | Application Server Primary Hostname |
| APPHOST2 | Application Server Secondary Hostname |
| APPOWNER | Application Owner |
| APPBASE | Application Base Path |
| IDENTITY FILE | Identify file location |
| STAGE | Filesystem on each server where the logs can be stored, |
| | and application binary backup can be saved. |

The first entry of the server_pass-file should point to source server. The entry of the server_pass-file would be as follows:
#DB>DBHOST1>DBHOST2>DBOWNER>ORCHOME>APPHOST1>APPHOST2>APPOWNER>APPBASE>IDENTITY_FILE>STAGE

The examples provided here are only for understanding purpose and not to limit the scope of this disclosure.

b) Database Configuration File Parameters (Database_Pass_File):

| Parameters | Descriptions |
|---|---|
| DB | Database Name |
| APPS | APPS User Credential |
| SYSTEM | SYS/SYSTEM User Credential |
| Weblogic | Weblogic User Credential |
| Sysadmin | SYSADMIN User credential |

c) Common Environment File Parameters (Common_Env.Sh)

| Parameters | Descriptions |
|---|---|
| v_MAILTO | Email id where the Alert needs to be sent |
| ANT_HOME | Location where ANT is installed |
| v_SCRIPT_HOME | Location for clone scripts |
| v_identityfile | Identity file location for jenkins user |

Once the central server receives the input from the end user regarding the target server which needs to be cloned, it validates if all the required parameters for the selected target server are defined in server configuration parameters files (server_pass-file) and in database configuration parameter files (database_pass_file). If any of the required parameters is null or not defined then the method will terminate. If all the required parameters are defined, then the central server access configuration parameters files (server_pass-file), database configuration parameter files (database_pass_file) and common environment files (common_env.sh) and collect all required parameters to clone the database and associated application of source server into the selected target server. Referring back to FIG. 1, if step 106 is successful, then at step 108, source and target server specific scripts are dynamically created based on one or more base scripts stored in a database of the central server. Base script is already known script to clone the database. Every database has the functionality inbuilt to it to generate the script to clone it. In this disclosure, the base script contains the static part and a placeholder for the dynamic part of the code which depends on the target server parameter values. The values which need to be collected from Configuration files as mentioned hereinabove, mentioned as variables in the base script. Once the end user selects the target server, the central server collects the required parameter values from the configuration files and passes these values to the base script to generate the final scripts which to be executed on the source and target server. If step 108 is successful, then at step 110, the dynamically generated scripts are sent to the source and target environment by using Secure Copy Protocol (SCP). The SCP is a well-known means of securely transferring computer files between local host or remote host or between two remote hosts. It is based on SSH protocol.

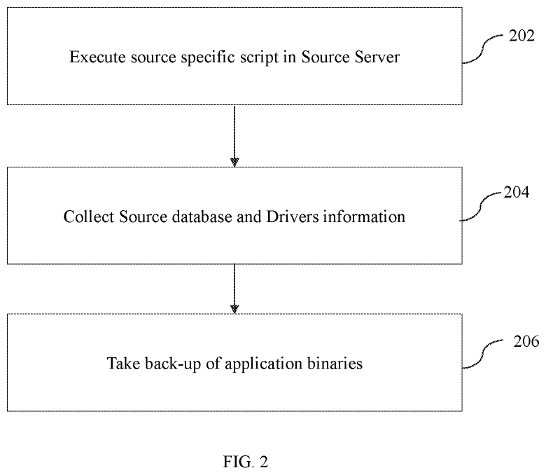

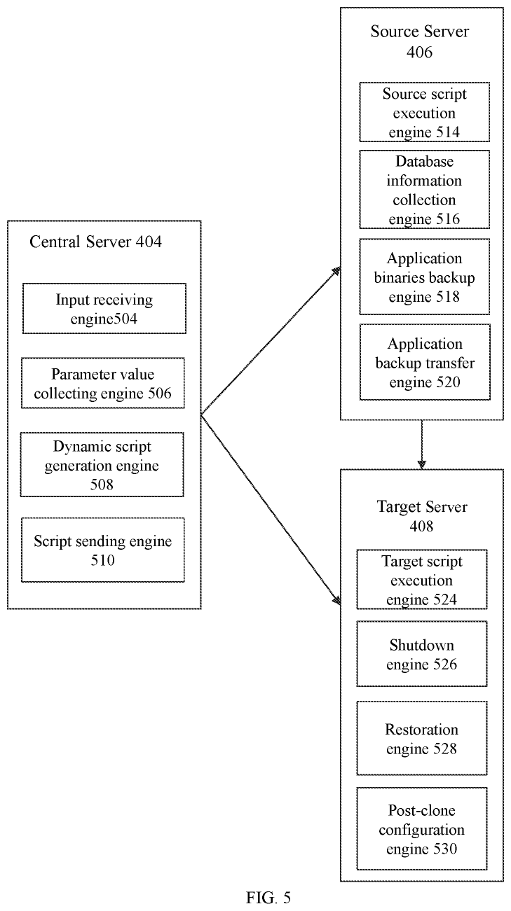

FIG. 2 is a flowchart, illustrating steps followed by the execution of source specific script on source server. Once the script is executed on the source server at step 202, the present technique collects all information related to source database and source drivers required to clone the database and application at step 204. The details of this process is described herein below with reference to database information collection engine 516 of FIG. 5. The backup of the source application is created at step 206 and at future step, the backup files of this application gets transferred from source server to the target server. This is described in detail herein below with reference to Application binaries backup Engine 518 and Application backup transfer Engine 520 of FIG. 5.

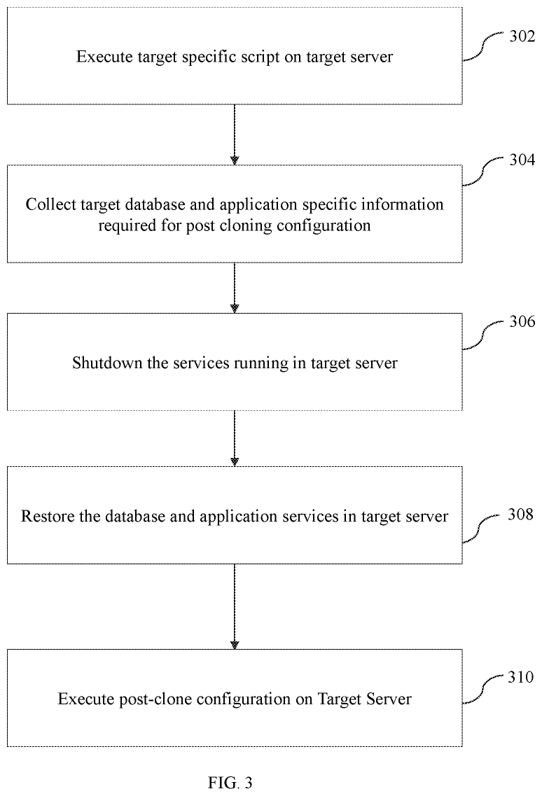

FIG. 3 is a flowchart, illustrating steps followed by the execution of target specific scripts on target server. Once target specific scripts are executed on target server at step 302, the present technique at step 304, collects all target database and application related information which are required in post-cloning configuration. The details of this process is described herein below with reference to target script execution engine 524 of FIG. 5. The scripts executed on target server also cause the target server services to shutdown at step 306, Database/Application restore at step 308 and post cloning configuration at step 310. The details about services shutdown, Database/application restore and post cloning configuration are described herein below with reference to target server shutdown engine 526, target server restoration engine 528 and target server post clone configuration engine 530 respectively of FIG. 5.

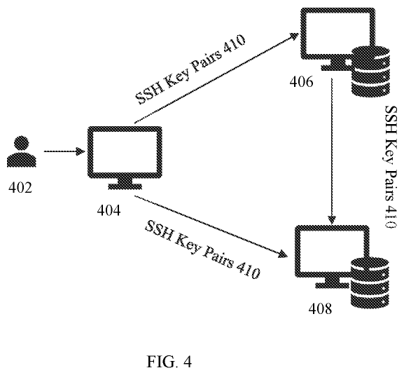

FIG. 4 is an environment diagram in which the method of cloning a database and associated application takes place, in accordance with an embodiment of the present technique. The environment consists of an end user 402, central server 404, source server 406 and target server 408. The end user 402 connects with the central 404 server through network to select the target server 408 where the cloning needs to be done. The central server 404, source server 406 and the target server 408 are interconnected through SSH protocol as described herein above. Through SSH protocol, central server 404 sends the source and target specific scripts to the source server 406 and target server 408 respectively. Source server 406 send the source database related information and application backup files to the target server 408. This technique is also applicable in multi node database and multi-node application.

FIG. 5 an architectural diagram of the system for cloning a database and associated application, in accordance with an embodiment of the present technique. The system comprises of central server 404, source server 406 and target server 408 connected with each other through SSH protocol. The central server 404 comprises of input receiving engine 504, parameter value collecting engine 506, dynamic script generation engine 508 and script sending engine 510. The input receiving engine 504 receives input from end user regarding the name of the source and target server where the cloning needs to be done and also verifies if all the parameter values for the selected source and target server is present in the Configuration files stored in central server 404. If all the required parameter values are not present in the configuration files, then the process gets terminated. The detail about this process is disclosed with reference to step 104 of FIG. 1. The parameter value collecting engine 506 collects the various parameter values corresponding to the selected target server from the Configuration files stored in the central server 404. The detail about this process is described herein above with reference to step 106 of FIG. 1. The dynamic script generation engine 508 generates the scripts to be executed on source server 406 and target server 408 by passing the parameter values obtained from configuration files to a base script stored in the central server 404. The detail about this process is described herein above with reference to step 108 of FIG. 1. The script sending engine 510 sends the dynamically generated scripts to the source server 406 and target server 408 by using Secure Copy Protocol (SCP). The details of this process is described herein above with reference to step 110 of FIG. 1.

The source server 406 comprises of source script execution engine 514, database information collection engine 516, application binaries backup engine 518 and application backup transfer engine 520. Source script execution engine 514 executes the script specific for source server received from central server 502. In an exemplary embodiment, if Oracle EBS needs to be cloned, then the script executes the command adpreclone.pl (adpreclone.pl is a standard command provided by Oracle EBS). The execution of the source specific script prepares the source system to be cloned by collecting information about the database by using database information collection engine 516 and creating generic templates and driver files from existing files that contain source-specific hard-coded values. These collected information is sent to the target server 408 through secured protocol which is part of application binaries backup engine 518. The application binaries backup engine 518 backs up the source application binaries using tar command (tar is standard Unix command widely used to create compressed archive files and that can be moved easily from one disk to another disk or machine to machine. It is also used to extract files from archive). The application backup transfer engine 520 transfer the backup taken by application binary backup engine 518 to target server 408 through secured protocol. If any of the step failed in this stage, the process exits with status failure by providing the details.

The target server 408 comprises of target script execution engine 524, target server shutdown engine 526, target server restoration engine 528 and target server post clone configuration engine 530. Target script execution engine 524 executes the target specific script which takes backup of (a) all the global configuration settings information for the database, (b) configuration files that define database addresses for establishing connections using unix cp command (cp is standard Unix command widely used to copying files from one location to another on same machine), (c) dba directories which point to operating system directory on the database server machine for reading and writing files and (d) various initialization parameters (cluster_database, db_file_name_convert, db_file_name_convert in init.ora) which are required in restoration stage. The target server shutdown engine 526 shuts down the application and database services in target server 408. For Stopping the application services, the script is executed on target server 408 which brings down the application services. In an exemplary embodiment of Oracle EBS cloning, the target server executes adstpall.sh (adstpall.sh is Oracle EBS provided instance specific script to stop all the services e.g. Weblogic Admin, Managed Server, Concurrent Manager, Apache and OPMN). Once the application services are down it also clears any process running on the server using fuser (fuser is a Unix utility used to find which process is using a file or a directory). Similarly, For stopping the database the script is executed on target server 408 which brings down the database using shutdown command then start the database in restricted mode and drop the database. This internally cleans up the datafiles on target server 408. target server restoration engine 528 restores the application and database running in the target server 408. For restoring the database, the script is executed on target server which dynamically generate a script which duplicates the database of the source server 406 on to the target server 408 by using a built in utility in the database itself. In an exemplary embodiment of cloning Oracle EBS, RMAN technique is followed. RMAN is a utility built into Oracle databases to automate backup and recovery process and also has the ability to duplicate a database. It also has the ability for configuring multi node database. For restoring the application, the script is executed on target server 408 which first cleans up the old application binaries using Unix rm command (rm command is helpful for removing files or directories). Once the cleanup is completed the application binaries backup which was transferred to the target server 408 from source server 406 is restored using tar command (tar is standard Unix command widely used to create compressed archive files and that can be moved easily from one disk to another disk or machine to machine. It is also used to extract files from archive). Target server post clone configuration engine 530 configures the database and application after restoration process is completed. For database configuration, the target server specific script recreates the dba directories which was backed up by target server execution engine 524. In addition to this, the commands are executed to clear tables which contain source server information and also to populate information of target server which we backed up by target server execution engine 524. In an exemplary embodiment of Oracle EBS cloning, the command FND_CONC_CLONE.SETUP_CLEAN is used to clean the source server information and command adautocfg.sh is used to populate target server information. For application post cloning configuration, the target specific script is executed which uses the templates and driver files those were created by source script execution engine 514 on the target environment. In an exemplary embodiment of Oracle EBS cloning, adcfgclone.pl utility is executed which uses the parameters to configure the target application. It also has the ability for configuring multi node application clusters. If it is multi node application, then it creates pairsfile (pairsfile is a basic text file which has context variables and values) to configure secondary application node (APPHOST2). For this, the already built in utilities in the database and application are used to configure the secondary application node. In an exemplary embodiment of Oracle EBS cloning, txkSetAppsConf.pl utility is used to configure the secondary application node. The target server post clone configuration engine 528 also performs the following actions:
(a) changes and updates the application password;
(b) shutdown the application;
(c) populate previously backed up information regarding target server 408 application;
(d) cancel all concurrent program which are not schedule by SYSADMIN user;
(e) update the site name profile values to display the clone information;
(f) upload user information and responsibilities which were backed up by target script execution engine 524; and
(g) start the application server.

In an exemplary embodiment of Oracle EBS cloning, Oracle utility FNDCPASS is used to change the application password, oracle utility txkManageDBConnectionPool.pl is used to update the application password, script adstpall.sh (already built in utility in Oracle EBS) is used to shutdown the application, script adautocfg.sh (already built in utility in Oracle EBS) is used to populate target server application information and use script adstrtal.sh (already built in utility in Oracle EBS) to start the application server.

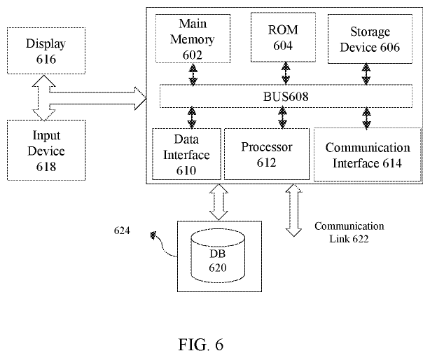

FIG. 6 is a diagram of a computer system with which the present technique can be implemented. In an embodiment of the technique, execution of the sequences of instructions required to practice the technique is performed by a single computer system. According to other embodiments of the technique, two or more computer systems coupled by a communication link 622 may perform the sequence of instructions required to practice the technique in coordination with one another. In order to avoid needlessly obscuring the technique, a description of only one computer system will be presented below; however, it should be understood that any number of computer systems may be employed to practice the technique. Each computer system may include a communication interface 614 coupled to the bus 608. The communication interface 614 provides two-way communication between computer systems. The communication interface 314 of a respective computer system transmits and receives electrical, electromagnetic or optical signals that include data streams representing various types of signal information, e.g., instructions, messages and data. A communication link 622 links one computer system with another computer system. For example, the communication link 622 may be a LAN, in which case the communication interface 614 may be a LAN card, or the communication link 622 may be a PSTN, in which case the communication interface 614 may be an integrated services digital network (ISDN) card or a modem.

A computer system may transmit and receive messages, data, and instructions, including program, i.e., application, code, through its respective communication link 622 and communication interface 614. Received program code may be executed by the respective processor(s) 612 as it is received, and/or stored in the storage device 306, or other associated non-volatile media, for later execution.

In an embodiment, the computer system operates in conjunction with a data storage system 606, e.g., a data storage system 624 that contains a database 620 that is readily accessible by the computer system. The computer system communicates with the data storage system 624 through a data interface 610. A data interface 610, which is coupled to the bus 608, transmits and receives electrical, electromagnetic or optical signals that include data streams representing various types of signal information, e.g., instructions, messages and data. In embodiments of the technique, the functions of the data interface 610 may be performed by the communication interface 614.

Computer system includes a bus 608 or other communication mechanism for communicating instructions, messages and data, collectively, information, and one or more processors 612 coupled with the bus 608 for processing information. Computer system also includes a main memory 602, such as a random access memory (RAM) or other dynamic storage device, coupled to the bus 608 for storing dynamic data and instructions to be executed by the processor(s) 612. The main memory 602 also may be used for storing temporary data, i.e., variables, or other intermediate information during execution of instructions by the processor(s) 612.

The computer system may further include a read only memory (ROM) 604 or other static storage device coupled to the bus 608 for storing static data and instructions for the processor(s) 612. A storage device 606, such as a magnetic disk or optical disk, may also be provided and coupled to the bus 608 for storing data and instructions for the processor(s) 612.

A computer system may be coupled via the bus 608 to a display device 606, such as, but not limited to, a cathode ray tube (CRT), for displaying information to a user. An input device 618, e.g., alphanumeric and other keys, is coupled to the bus 608 for communicating information and command selections to the processor(s) 612.

According to one embodiment of the technique, an individual computer system performs specific operations by their respective processor(s) 612 executing one or more sequences of one or more instructions contained in the main memory 602. Such instructions may be read into the main memory 602 from another computer-usable medium, such as the ROM 604 or the storage device 606. Execution of the sequences of instructions contained in the main memory 602 causes the processor(s) 612 to perform the processes described herein. In alternative embodiments, hard-wired circuitry may be used in place of or in combination with software instructions to implement the technique. Thus, embodiments of the technique are not limited to any specific combination of hardware circuitry and/or software.

The term “computer-usable medium,” as used herein, refers to any medium that provides information or is usable by the processor(s) 612. Such a medium may take many forms, including, but not limited to, non-volatile, volatile and transmission media. Non-volatile media, i.e., media that can retain information in the absence of power, includes the ROM 604, CD ROM, magnetic tape, and magnetic discs. Volatile media, i.e., media that cannot retain information in the absence of power, includes the main memory 602. Transmission media includes coaxial cables, copper wire and fiber optics, including the wires that comprise the bus 608. Transmission media can also take the form of carrier waves; i.e., electromagnetic waves that can be modulated, as in frequency, amplitude or phase, to transmit information signals. Additionally, transmission media can take the form of acoustic or light waves, such as those generated during radio wave and infrared data communications.

The above mentioned description is presented to enable a person of ordinary skill in the art to make and use the technique and is provided in the context of the requirement for obtaining a patent. Various modifications to the preferred embodiment will be readily apparent to those skilled in the art and the generic principles of the present technique may be applied to other embodiments, and some features of the present technique may be used without the corresponding use of other features. Accordingly, the present technique is not intended to be limited to the embodiment shown but is to be accorded the widest scope consistent with the principles and features described herein.

What is claimed is:

1. A computer implemented method for cloning a database and associated application comprising:
connecting, by a processor of a central server, the central server to a source server and one or more target servers through a network;
receiving, by the processor of the central server, at least one input from a device of an end user, wherein the at least one input comprises an identifier of one of the one or more target servers to clone the database and associated application from the source server;
collecting, by the processor of the central server, one or more parameter values related to the one of the one or more target servers selected by the end user from one or more configuration files stored in a repository of the central server;
dynamically generating, by the processor of the central server, a source specific script to be executed on the source server and one or more target specific scripts to be executed on the one of the one or more selected target servers; and
transferring, by the processor of the central server, the source specific script to the source server and the one or more target specific scripts to the one of the one or more selected target servers through the network to clone the database and associated application from the Source server to the one of the one or more selected target servers.

2. The method of claim 1, wherein the central server is connected to the source server and the one or more target servers through Secure Socket Shell (SSH) protocol.

3. The method of claim 1, wherein the central server verifies when the one or more parameter values corresponding to the one of the one or more target servers selected by the end user is present in the one or more configuration files.

4. The method of claim 3, wherein the cloning process is terminated when the one or more parameter values corresponding to the one of the one or more target servers selected by the end user is not present in the one or more configuration files.

5. The method of claim 1, wherein execution of the source specific script creates a backup of application file.

6. The method of claim 5, wherein the backup application file is transferred to the one of the one or more selected target servers through execution of source specific scripts.

7. The method of claim 1, wherein the source and target specific scripts are dynamically generated by passing the one or more parameter values to one or more base scripts stored in the central server.

8. The method of claim 1, wherein the one or more target specific script contains instructions to shutdown the services running on the one of the one or more selected target servers.

9. The method of claim 1, wherein the one or more target specific script contains instructions to restore the database and associated application in the one of the one or more selected target servers.

10. The method of claim 1, wherein the one or more target specific script contains instructions to perform configuration of the database and associated application in the one of the one or more selected target servers.

11. A system for cloning a database and associated application comprising:
one or more processors; and
one or more memories operatively coupled to at least one of the one or more processors and having instructions stored thereon that, when executed by at least one of the one or more processors, cause the at least one of the one or more processors to:
connect a central server to a source server and one or more target servers through a network;
receive at least one input by the central server from a device of an end user, wherein the at least one input comprises an identifier of one of the one or more target servers to clone the database and associated application from the source server;
collect one or more parameter values related to the one of the one or more target servers selected by the end user from one or more configuration files stored in a repository of the central server;
dynamically generate a source specific script to be executed on the source server and one or more target specific scripts to be executed on the one of the one or more selected target servers;
transfer the source specific script to the source server and the one or more target specific scripts to the one of the one or more selected target servers through the network to clone the database and associated application from the source server to the one of the one or more target servers.

12. The system of claim 11, wherein the central Server is connected to the source server and the one or more target servers through Secure Socket Shell (SSH) protocol.

13. The system of claim 11, wherein the central server verifies when the one or more parameter values corresponding to the one of the one or more target servers selected by the end user is present in the one or more configuration files.

14. The system of claim 13, wherein the cloning process is terminated when the one or more parameter values corresponding to the one of the one or more target servers selected by the end user is not present in the one or more configuration files.

15. The system of claim 11, wherein the source specific script comprises instructions to create a backup application file.

16. The system of claim 15, wherein the backup application file is transferred to the one of the one or more selected target servers through execution of the one or more target specific scripts.

17. The system of claim 11, wherein the source and target specific scripts are dynamically generated by passing the one or more parameter values to one or more base scripts stored in the central server.

18. The system of claim 11, wherein the one or more target specific scripts contains instructions to shutdown services running on the one of the one or more selected target servers.

19. The system of claim 11, wherein the one or more target specific script contains instructions to restore the database and associated application in the one of the one or more selected target servers.

20. The system of claim 11, wherein the one or more target specific script contains instructions to perform configuration of the database and associated application in the one of the one or more selected target servers.

21. A non-transitory computer readable medium having stored thereon instructions for cloning a database and associated application, the non-transitory computer readable medium comprising machine executable code which when executed by at least one processor, causes the at least one processor to perform steps comprising:
connecting a central server to a source server and one or more target servers through a network;
receiving at least one input by the central server from a device of an end user, wherein the at least one input comprises an identifier of one of the one or more target servers to clone the database and associated application from the source server;
collecting one or more parameter values related to the one of the one or more target servers selected by the end user from one or more configuration files stored in a repository of the central server;
dynamically generating a Source specific script to be executed on the source server and one or more target specific scripts to be executed on the one of the one or more selected target servers by passing the one or more parameter values to one or more base scripts stored in the central server; and
transferring the source specific script to the source server and the one or more target specific scripts to the one of the one or more selected target servers through the network to clone the database and associated application from the source server to the one of the one or more selected Target environment.
